(19) United States
(12) Patent Application Publication
(10) Pub. No.: US 2006/0053762 A1
(43) Pub. Date: Mar. 16, 2006

(54) Walk-behind implement and handle system for use with same

(76) Inventors: Dale A. Stover, Plymouth, MN (US); Kevin D. Docken, Chanhassen, MN (US)

Correspondence Address: MUETING, RAASCH & GEBHARDT, P.A., P.O. BOX 581415, MINNEAPOLIS, MN, 55458, US

(21) Appl. No.: 10/942,427

(22) Filed: Sep. 16, 2004

(51) Int. Cl. A01D 34/64

(52) U.S. Cl. 56/16.7

(57) ABSTRACT

A walk-behind implement, e.g., lawn mower, having a handle system including a handle assembly and, in one embodiment, a handle assembly release apparatus. The release apparatus may permit unlocking of the handle assembly, relative to a housing of the implement, from a first operating position. Once unlocked, the handle assembly may be moved, e.g., pivoted, to a second storage position. In one embodiment, the release apparatus may include a lever member that may be actuated by the application of a force applied by an operator, e.g., via hand or foot. The handle assembly may alternatively or additionally include an upper section that is adjustably positionable relative to a lower section.

### TECHNICAL FIELD

The present invention relates generally to a walk-behind power equipment unit or implement (e.g., lawn mower) having a handle system and, more specifically, to a handle system that allows movement of an implement handle assembly between multiple positions.

### BACKGROUND

Rotary lawn mowers are generally known in the art. Typically, such mowers include a wheeled housing forming a cutting chamber which surrounds a rotatable cutting blade. A generally U-shaped handle assembly may extend upwardly and rearwardly from the housing to allow a walking operator to guide and manipulate the mower. The handle assembly may include two transversely spaced handle members, e.g., tubes, joined together at their respective upper ends by a cross tube forming a hand grip portion of the handle assembly. The handle assembly may be rigidly locked to the housing during operation of the mower so that the user may impart directional and control forces to the mower through the handle assembly.

While effectively configured for operation, the handle assembly, when in this conventional operating position, may extend substantially beyond the mower housing. Thus, the mower may take up what is considered to be excessive room when not in use. That is, when the mower is stored with the handle assembly in its conventional operating position, the mower may have a relatively large storage footprint.

To remedy this situation, mowers in which the handle assembly folds relative to the housing have been developed. Such a foldable handle assembly is usually pivotally connected, at its lower end, to the mower housing and is often formed in two sections—a lower section and an upper section—which may also be pivotally connected to one another. Locking mechanisms are provided for securing the handle assembly in its conventional operating position. However, when the locking mechanisms are released, the handle assembly may be pivoted relative to the housing until the lower section of the handle assembly extends generally over the housing. In some mower configurations, the upper section of the handle assembly may also be folded back over the lower section to further reduce storage space requirements.

While effective, many implementations of foldable handle assemblies do have drawbacks such as, for instance, requiring time consuming and/or complex manual interaction on the part of the operator to initiate folding. To illustrate, many folding handle assemblies require that the user unlock both handle members from the housing to allow the handle assembly to be pivoted to its stored position. Since the locking mechanisms are usually at the base of the handle assembly (near where the lower ends of the handle members connect to the housing) simultaneous manipulation of the locking mechanism on each side of the mower housing may involve bending down, or even getting on one's knees. Such interaction may be inconvenient, or for some operators, difficult to accomplish.

Yet another drawback to many existing lawn mowers is that the handle assembly may provide only a single operating position. As a result, a hand grip section of the handle assembly may be generally fixed at a particular height above the ground surface. While the fixed height grip section may be selected to accommodate a large range of potential users, operators that are substantially taller (or shorter) may prefer a hand grip section that is positioned at a higher (or lower) elevation.

### SUMMARY

The present invention is directed to walk-behind implements and handle systems that addresses the above-identified drawbacks. For example, in one embodiment, a walk-behind power equipment unit is provided, including a housing operable for movement over a surface. A handle assembly having a first and a second handle attachment member is also provided, wherein the first and second handle attachment members are pivotally coupled to the housing. Also included is a handle assembly release apparatus having interconnected and transversely offset first and second locking portions each pivotally coupled to the housing. The first and second locking portions operatively engage the first and second handle attachment members, respectively, to lock the handle assembly in a first operating position.

In another embodiment, a handle system for use with a walk-behind power equipment unit having a housing operable for movement over a surface is provided. The handle system includes: a handle assembly having a first and a second handle attachment member each pivotally coupled to the housing, wherein the handle assembly may pivot, relative to the housing, between a first operating position and a second storage position. A handle assembly release apparatus is also provided and coupled to the housing. The release apparatus includes interconnected and transversely offset first and second locking portions for operatively engaging the first and second handle attachment members, respectively, to secure the handle assembly in the first operating position.

In still another embodiment, a walk-behind lawn mower is provided. The mower includes a housing operable for movement over a ground surface, and a handle assembly having a first handle attachment member and a transversely offset second handle attachment member. Also included are a first hub attached to a first end of the first handle attachment member and a second hub attached to a first end of the second handle attachment member, wherein the first and second hubs are each pivotally coupled to the housing. A handle assembly release apparatus is also included and coupled to the housing. The release apparatus includes interconnected first and second locking portions operable to selectively engage the first and second hubs, respectively, to lock the handle assembly in a first operating position.

In yet another embodiment, a walk-behind lawn mower is provided having: a housing operable for movement over a ground surface; and a handle system attached to the housing. The handle system includes a lower section having first and second handle attachment members each pivotally coupled to the housing, wherein the lower section may pivot between a first operating position and a second storage position. Also included is an upper section having a gripping portion, the upper section coupled to the lower section, wherein the upper section selectively pivots, relative to the lower section, between two or more use positions.

The above summary is not intended to describe each embodiment or every implementation of the present invention. Rather, a more complete understanding of the invention will become apparent and appreciated by reference to the following Detailed Description of Exemplary Embodiments and claims in view of the accompanying figures of the drawing.

### BRIEF DESCRIPTION OF THE VIEWS OF THE DRAWING

The present invention will be further described with reference to the figures of the drawing, wherein:

FIG. 1 is a perspective view of a walk-behind implement, e.g., lawn mower, having a handle system in accordance with one embodiment of the invention, wherein the handle system includes a handle assembly (shown in a first operating position) and a handle assembly release apparatus;

FIGS. 2A-2B are side elevation views of the lawn mower of FIG. 1, wherein: FIG. 2A illustrates the handle assembly in the first operating position (in broken lines) and in a second storage position; and FIG. 2B illustrates the handle assembly (with an upper section collapsed or folded) in the second storage position (in broken lines) and in a third long term storage position;

FIGS. 3A-3B are first (e.g., left) side elevation views of the handle system of FIGS. 1 and 2A-2B, wherein: FIG. 3A illustrates the handle assembly in the second storage position; and FIG. 3B illustrates the handle assembly in the first operating position;

FIGS. 4A-4B are second (e.g., right) side elevation views of the handle system of FIGS. 1 and 2A-2B, wherein: FIG. 4A illustrates the handle assembly in the second storage position; and FIG. 4B illustrates the handle assembly in the first operating position;

FIG. 5 is an exploded partial perspective view of the handle system of FIGS. 1 and 2A-2B;

FIGS. 6A-6B are side elevation views of the handle assembly illustrated in FIG. 1, wherein: FIG. 6A illustrates the upper section of the handle assembly in a first use position; and FIG. 6B illustrates the upper section in a second use position;

FIG. 7 is an exploded view of a handle system pivot assembly in accordance with one embodiment of the invention;

FIG. 8 is an enlarged partial exploded view of the pivot assembly illustrated in FIG. 7; and

FIGS. 9A-9B are cutaway views of the pivot assembly of FIGS. 7 and 8, wherein: FIG. 9A illustrates the upper section of the handle assembly in the first use position; and FIG. 9B illustrates the upper section in the second use position.

### DETAILED DESCRIPTION OF EXEMPLARY EMBODIMENTS

In the following detailed description of illustrative embodiments of the invention, reference is made to the accompanying figures of the drawing which form a part hereof, and in which are shown, by way of illustration, specific embodiments in which the invention may be practiced. It is to be understood that other embodiments may be utilized and structural changes may be made without departing from the scope of the present invention.

The present invention, in one embodiment, is directed to handle systems and methods for permitting releasing or unlocking of a handle assembly of a walk-behind power equipment unit or implement, e.g., a rotary lawn mower, from a first operating position, where it may then be positioned in at least a second storage position. As a result, the footprint of the implement may be quickly and easily reduced for storage. The handle assembly may alternatively or additionally include an upper section that is pivotally coupled to the rest of the handle assembly. As a result, operators of different heights may select an operating or use position of a gripping portion of the handle assembly that suits their particular preference.

While described herein in the context of a walk-behind rotary lawn mower, those of skill in the art will appreciate that the apparatus and methods of the present invention could be used with most any walk-behind device or implement including, for example, reel mowers, string mowers, snow throwers, tillers, aerators, and other ground and floor working equipment.

Horizontal, vertical, and other similar terms may be used herein to identify general directions and/or orientations of various parts and assemblies. It is to be understood that these terms are not necessarily absolute, e.g., horizontal (or vertical) may be used to indicate an element that is substantially horizontal (or vertical).

Moreover, relative terms such as left, right, forward, rearward, top, bottom, upper, lower, horizontal, vertical, and the like may be from the perspective of one operating the mower 50. These terms are used herein to simplify the description, however, and not to limit the scope of the invention in any way.

The reference numeral suffixes “a” and “b” may be used throughout this description to denote various left and right side parts/features, respectively. However, unless otherwise noted, the parts/features denoted with “a” and “b” suffixes are substantially identical to, or mirror images of, one another. Unless otherwise noted, the description of an individual part/feature (e.g., the description of a part/feature identified with an “a” suffix) also applies to the opposing part/feature (e.g., the part/feature identified with a “b” suffix). Similarly, unless otherwise noted, the description of a part/feature identified with no suffix may apply to both the part/feature identified with the “a” suffix and the “b” suffix.

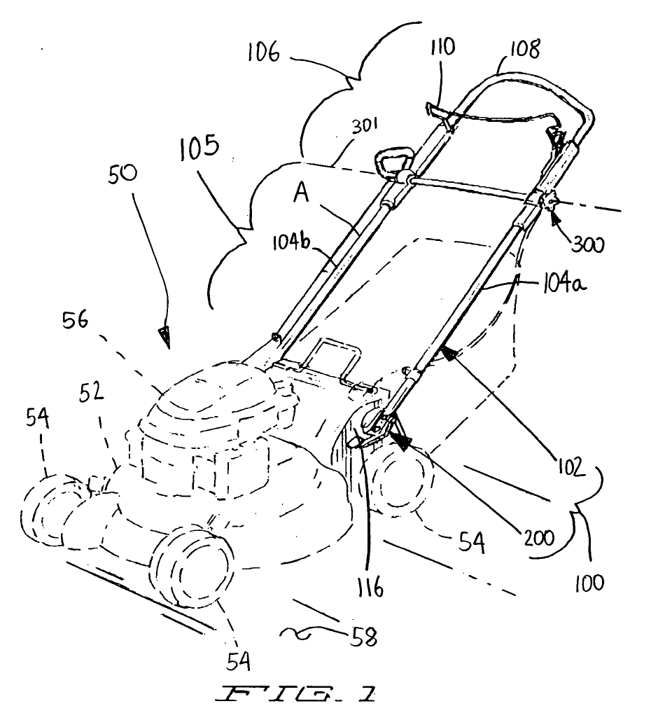

Referring to FIG. 1, an exemplary handle system of a walk-behind power equipment unit, e.g., a rotary lawn mower 50, is generally indicated as 100. The handle system 100 may include a handle assembly 102 and a handle assembly release apparatus 200, both further described below.

The handle assembly 102 may form a generally U-shaped structure that includes a lower section 105 defined by a first and a second handle attachment member, e.g., upwardly extending handle attachment members 104a and 104b. In some embodiments, the U-shape is defined by an upper section 106 of the handle assembly 102 that couples to the lower section 105. The upper section 106 may include a transverse gripping portion 108 that is operable to receive hands of an operator during operation of the mower 50. The handle assembly 102 may also include operator controls such as throttle (not shown) and blade and/or drive control bales 110 (shown only in FIG. 1).

The handle attachment members 104 may be generally tubular in shape. However, at their respective lower ends, they may each transition to a flat or arc shape for coupling with the mower 50.

The mower 50 may include a housing 52 having two or more ground engaging members such as wheels 54 that allow rolling movement of the housing 52 over a surface, e.g., ground surface 58. A rotatable cutting element or blade (not shown) may rotate within a cutting chamber formed by the housing 52. The cutting element may sever grass or other vegetation at a pre-determined height above the ground during operation. A prime mover, e.g., internal combustion engine 56, may provide rotational power to the cutting element and, optionally, driving power to one or more of the wheels 54. The handle assembly 102 may permit operator control and manipulation of the mower 50 during use.

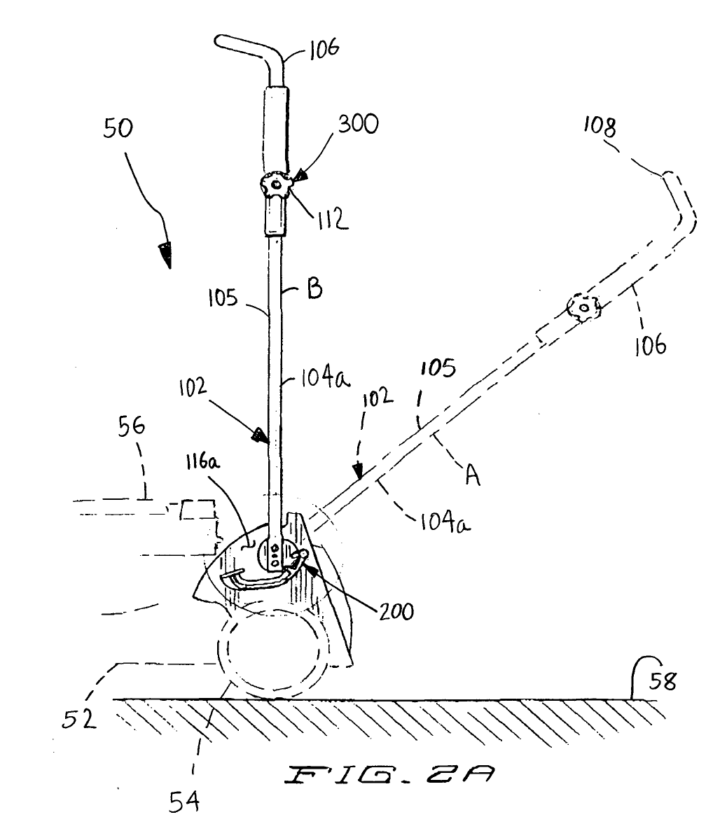

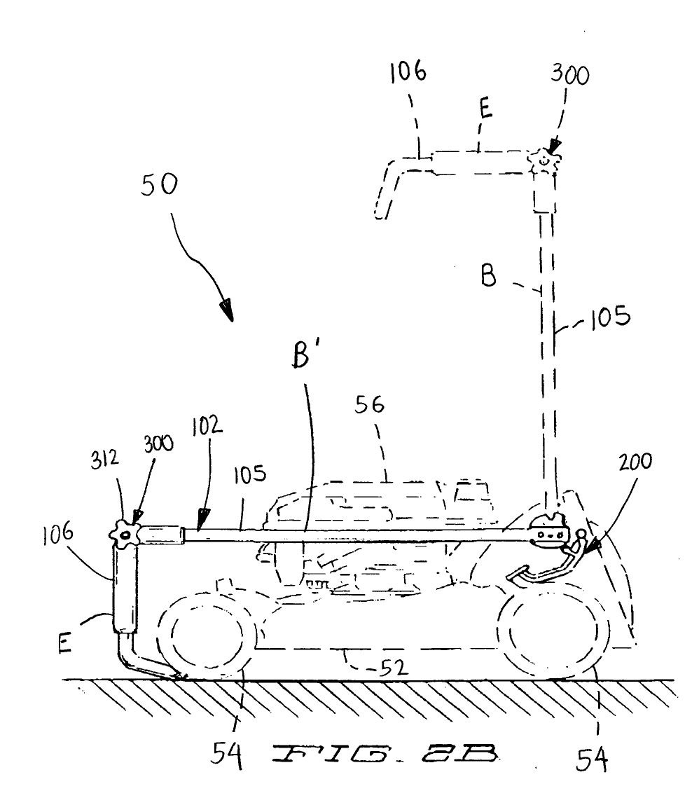

Generally speaking, systems and methods of the present invention permit selective unlocking or releasing of the handle assembly 102 from the first operating position (position A in FIGS. 1 and 2A) by manipulation of the handle assembly release apparatus 200. Once unlocked, the handle assembly 102 may be moved, e.g., pivoted, to at least the second storage position (position B in FIG. 2A). In some embodiments, the handle assembly release apparatus 200 is configured so that it is easily actuatable by an operator's hand or foot as further described below. That is, the operator may unlock the handle assembly 102 from the first operating position A and move it to the second storage position B by actuating the handle assembly release apparatus 200, e.g., with his or her hand or foot, and moving the handle assembly.

Handle systems in accordance with other embodiments of the present invention may permit adjustment of the upper section 106 (e.g., the gripping portion 108) relative to the lower section 105 (e.g., the handle attachment members 104). The sections 105 and 106 may be connected to one another at a pivot assembly 300 that allows relative pivoting about a transverse horizontal pivot axis 301. As a result, the height of the gripping portion 108 may be adjusted to accommodate the preferences of different operators.

FIG. 2A shows a side elevation view of the mower 50. As shown in this view, each handle attachment member 104 may connect, e.g., at its respective lower (proximate) end, to the housing 52 of the mower 50. In the illustrated embodiments, the housing 52 may include a vertical wall 116 along each side of the mower 50. While the members 104 are shown as coupling near a rear side of the housing 52, they may, in other embodiments, be coupled at most any location on the housing. FIG. 2B illustrates the handle assembly 102 in a third long-term storage position as further described below.

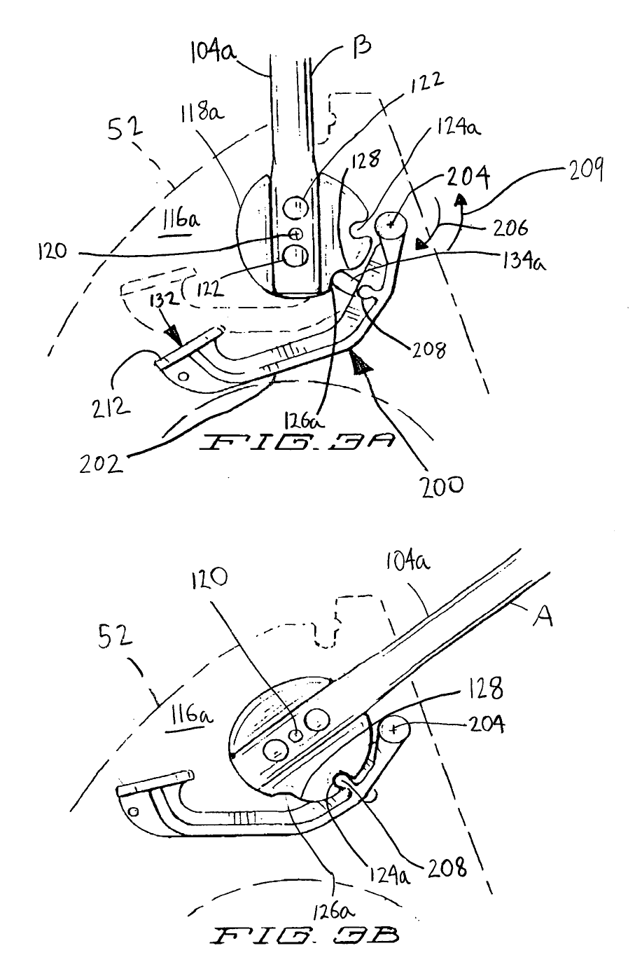

FIGS. 3A and 3B illustrate enlarged elevation views of the left side of the mower 50 of FIG. 1 in the vicinity of the vertical wall 116a. As illustrated in these views, the release apparatus 200 may include an actuation member, e.g., lever member 202, pivotally coupled to the housing 52 for pivoting about a transverse horizontal pivot axis 204. The lever member 202 may be biased in a first direction 206 such that a first locking portion 208 associated with the lever member 202 is biased towards the proximal end of the handle attachment member 104a. The first locking portion 208 may, in one embodiment, be formed by a protrusion on the lever member 202. The first locking portion 208 may operatively hold the handle attachment member 104a in either the first operating position A or the second storage position B.

In the illustrated embodiment, the handle attachment member 104a may include a first hub 118a at its first or proximal end. The hub 118a may rigidly attach to the member 104a, e.g., via fasteners 122. The hub 118a may, in turn, be pivotally coupled to the wall 116a as further described below for pivoting about a pivot axis 120.

The hub 118a may include one or more positioning surfaces, e.g., recesses, located along its peripheral edges. The recesses may be operable to engage the first locking portion 208 of the lever member 202. For example, the hub 118a may include a first recess 124a positioned to engage the first locking portion 208 when the handle assembly 102 is in the first operating position A of FIG. 3B. Similarly, the hub 118a may include a second recess 126a positioned to engage the first locking portion 208 when the handle assembly 102 is in the second storage position B of FIG. 3A.

The shape of the first recess 124a is preferably configured to engage the first locking portion 208 sufficiently to prevent pivoting of the handle assembly 102 in either direction about the axis 120 (unless the apparatus 200 is actuated). As a result, control forces applied to the handle assembly 102 by the operator may be mostly transmitted to the housing 52 to guide the mower 50.

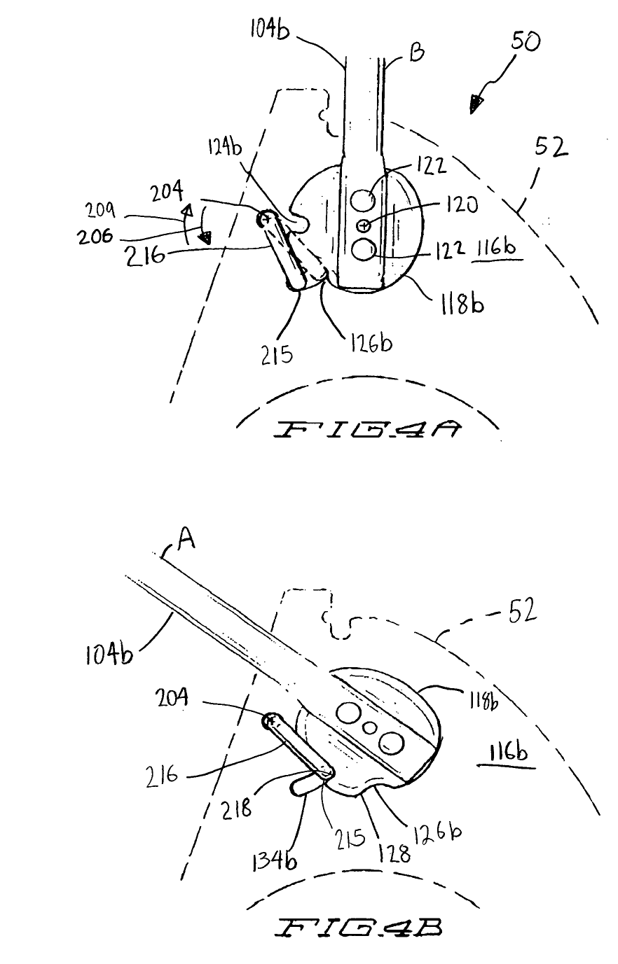

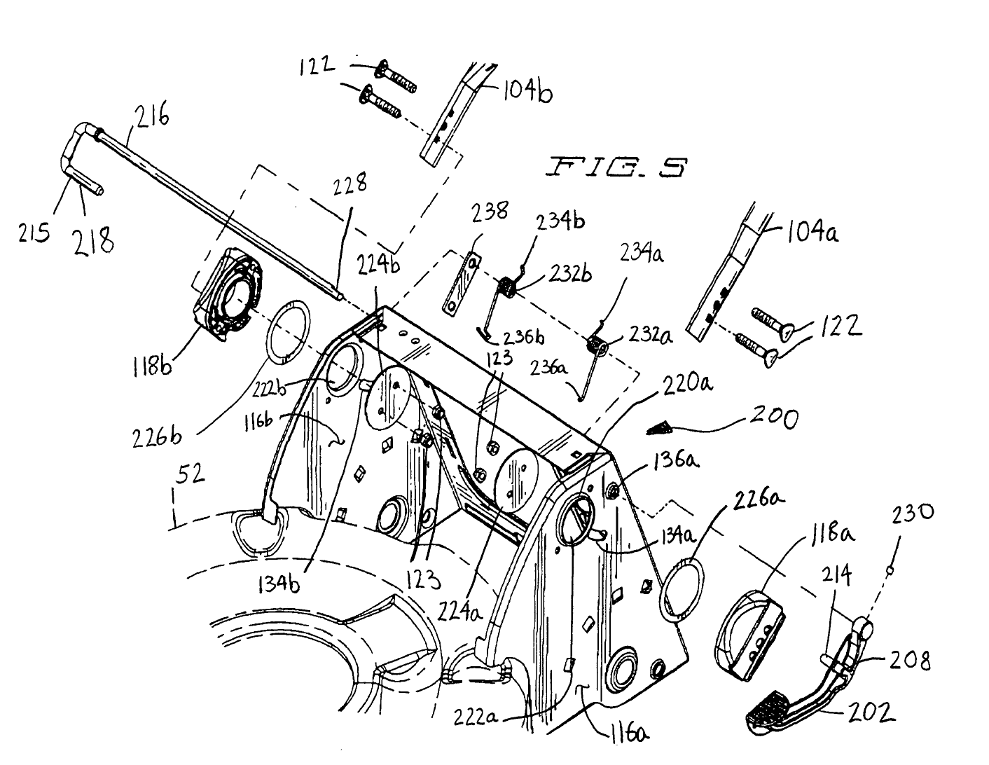

FIGS. 4A and 4B illustrate enlarged elevation views of the right side of the mower 50 in the vicinity of the vertical wall 116b. The configuration of the handle system 100 on this side of the mower is similar in many respects to the left side illustrated in FIGS. 3A and 3B. However, a lever member is not necessarily required on this side. Rather, the right side of the mower 50 may use a second locking portion 215 formed, in the illustrated embodiment, by an end of a transverse member, e.g., crossbar 216 (shown in FIG. 5). The crossbar 216 may have its opposing end coupled to the lever member 202, as further described below, such that the crossbar 216 moves in unison with the lever member. The crossbar 216 may further be journalled to the housing 50 such that it pivots about the pivot axis 204. The crossbar 216 may be bent to form a tab or protrusion 218 (see FIG. 5).

As with the proximal end of the handle attachment member 104a, the member 104b may also include, or otherwise be attached to, a second hub 118b. In the illustrated embodiment, the member 104b is coupled to the second hub 118b with fasteners 122. The hub 118b may then be pivotally coupled to the wall 116a as further described below for pivoting about the pivot axis 120. Moreover, like the hub 118a, the hub 118b may include one or more positioning surfaces, e.g., recesses, located along its peripheral edges and operable to engage the second locking portion 215 in a manner substantially similar to that described with respect to the first locking portion 208. For example, the hub 118b may include a first recess 124b positioned to engage the second locking portion 215 when the handle assembly 102 is in the first operating position A of FIG. 4B. In addition, the hub 118b may include a second recess 126b positioned to engage the second locking portion 215 when the handle assembly 102 is in the second storage position B of FIG. 4A.

The shape and function of the first recess 124b, the second recess 126b, and the second locking portion 215 are generally similar to that of the corresponding first recess 124a, second recess 126a, and first locking portion 208, respectively, described above.

An exploded view of the handle assembly release apparatus 200 of FIGS. 1, 2A-2B, 3A-3B, and 4A-4B is illustrated in FIG. 5. As illustrated in this view, each hub 118 may be configured to seat against and ride upon a flange 220 formed along a periphery of an opening 222 on each vertical wall 116. A retaining plate 224 may be positioned on an inner side of each vertical wall 116 in a position generally opposite its respective hub 118. In the illustrated embodiment, the fasteners 122 may, on each side of the mower 50, pass through the handle attachment member 104, the hub 118, and the respective retaining plate 224. The fasteners 122 may engage nuts 123 on an inner side of the retaining plates 224 as indicated in FIG. 5. As a result, the hubs 118 and handle attachment members 104 may be pivotally coupled to the mower housing 52.

The interface between each hub 118 and its respective flange 220 is preferably designed to allow generally unimpeded rotation between the hub and flange. In some embodiments, a friction washer 226, e.g., a nylon disc, may sit between each hub 118 and its corresponding vertical wall 116 to reduce friction and wear between the hub 118 and housing 52.

When the mower is fully assembled, the hubs 118 may be considered to be part of their respective handle attachment members 104. In fact, in other embodiments, the hub 118 could be integrally formed with, or permanently attached to (e.g., welded), an end of each handle attachment member 104. Alternatively, the proximal end of each handle attachment member 104 could be configured to eliminate the need for a hub-like component. For example, the proximal end of each handle attachment member 104 could include one or more recesses operable to engage the locking portions as described herein. In these instances, the need for a separate hub component as described above could be eliminated.

The crossbar 216 (which, in the illustrated embodiment, is a single round shaft bent to provide the desired shape, but could, in other embodiments, be assembled from multiple components) may pass through coaxial openings 136 (only opening 136a shown in FIG. 5) formed in the vertical walls 116. The openings 136 are configured to journal the crossbar 216 such that it may pivot relative to the vertical walls 116. When completely inserted, the transverse crossbar 216 extends beyond the vertical wall 116a a sufficient distance to permit coupling with the lever member 202. In one embodiment, the end of the crossbar 216 proximate the lever member 202 may include a flat 228. The flat 228 may engage a similar flat formed in an opening (not shown) of the lever member 202. A fastener, e.g., set screw 230, may threadably engage the lever member 202 and secure the latter to the crossbar 216.

The crossbar 216 may also extend through one or more biasing members, e.g., torsion springs 232a and 232b. The torsion springs 232 are configured to bias the crossbar 216, and thus the lever member 202, in the first direction 206 (see FIGS. 3A and 4A). The torsion springs 232 have a first leg 234 that engages a rear wall of the mower housing 52. A second leg 236a of the torsion spring 232a may engage the lever member 202 (e.g., engage a tab 214 formed on the lever member), while a second leg 236b of the torsion spring 232b may engage the protrusion 218. Both the tab 214 and the protrusion 218 may include features, e.g., notches, that receive the respective second legs 236 to assist in maintaining the position of the torsion springs 232.

A stiffener 238 may be provided to reduce relative deflection of the protrusion 218 relative to the crossbar 216. The stiffener 238 may be configured as a flat plate that slides over the crossbar 216 and the protrusion 218. The stiffener 238 may be held in place against an inner side of the vertical wall 1116b by the torsion spring 232b.

During operation, the mower 50 may be configured as generally illustrated in FIG. 1. That is, the handle assembly 102 may be in the first operating position A and the handle assembly release apparatus 200 may be configured as shown in FIGS. 3B and 4B. In this configuration, the first and second locking portions 208 and 215 are engaged with the respective first recesses 124a and 124b to generally lock the handle assembly 102 relative to the mower housing 52 in the first operating position A. The locking portions 208 and 215 may be maintained in the recesses 124 by the biasing force provided by the torsion springs 232.

To move the handle assembly 102 out of the first operating position A of FIG. 3B, the operator may apply an actuation force to the lever member 202. Actuation may occur by application of a downward force 132 to an actuating surface 212 of the lever member 202 as shown in FIG. 3A. Such a force may overcome the bias applied by the torsion springs 232 and cause the lever member 202 to rotate in the second direction 209. As the lever member 202 rotates in the second direction, the crossbar 216 also rotates. Because the lever member 202 is operatively coupled to both the first locking portion 208 and the second locking portion 215, both the first and second locking portions withdraw from their respective recesses 124a and 124b.

The wall 116a may include a slot 134a that receives therein the tab 214 (see FIG. 5) of the lever member 202. The wall 1116b may similarly include a slot 134b that receives therein the protrusion 218. The slots 134 may provide a mechanical stop to limit the pivotal movement of the lever member 202 and crossbar 216 during actuation.

With the locking portions 208 and 215 displaced from the hubs 118, the handle assembly 102 may pivot about the pivot axis 120. The operator may then apply a manual force to the handle assembly 102 to move it from the first operating position A towards the second storage position B (see FIG. 2A). Once the handle assembly 102 has been pivoted such that the first and second locking portions 208 and 215 no longer engage their respective recesses 124a and 124b, the force 132 applied to the lever member 202 may be removed. The locking portions 208 and 215 may then ride along the surface of the hubs 118 until they reach and engage their respective second recesses 126. The second recesses 126, as discussed above, correspond to the handle assembly 102 being in the second storage position B of FIGS. 2A, 3A, and 4A.

Because the mower 50 does not require the same rigidity of the handle assembly 102 relative to the housing 52 when the handle assembly is in the second storage position B, the second recesses 126 may be shallower as illustrated in FIGS. 3A, 3B, 4A, and 4B. In some embodiments, this reduced need for rigidity may also result in eliminating the second recess 126 on one of the hubs 118 (e.g., a single second recess may be sufficient to hold the handle assembly 102 in the second storage position B). Regardless of the particular configuration of the second recess(es) 126, the engagement between the locking portions 208 and 215 and the second recess(es) is preferably sufficient to hold the handle assembly 102 in the second storage position.

In another embodiment, the second recesses 126 could be removed from both hubs 118. In this instance, the handle assembly could be held in the second storage position B by frictional forces, e.g., the frictional force applied by the locking portions 208 and 215 bearing directly on the hubs 118.

Unlike the first recesses 124, the second recesses 126 may include a ramped edge 128 (see FIGS. 3B and 4B). That is, the second recesses 126 may function more as detents to generally hold the handle assembly in the second storage position B rather than locking and securing it relative to the housing 52. As a result, the operator may reposition the handle assembly 102 back to the first operating position A by pulling rearwardly on the handle assembly. This action will allow the first and second locking portions 208 and 215 to ride up the ramp (“cam out”) of the second recesses 126 and travel towards the first recesses 124 without actuation of the lever member 202. That is, no direct operator interaction with the handle assembly release apparatus 200 is required to move the handle assembly 102 from the second storage position B. Once the locking portions 208 and 215 reach the appropriate location, they may again engage their respective first recesses 124 and securely lock the handle assembly 102 in the first operating position A.

The handle assembly 102 may also be pivoted forwardly from the second storage position B to a third, long-term storage position B′ as shown in FIG. 2B. To move the handle assembly to this third position B′, the locking portions 208 and 215 may be disengaged from the second recesses 126 (e.g., by actuation of the lever member 202) and the handle assembly pivoted forwardly, e.g., until the handle attachment members 104 lie over the housing 52. A third recess (not shown) in one or both hubs 118 could optionally be provided to provide a detent when the handle assembly 102 reaches the third long-term storage position B′. In some embodiments, the upper section 106 of the handle assembly 102 may also be pivoted relative to the lower section 105 to further reduce storage volume as indicated in FIG. 2B and further described below.

To return the handle assembly 102 from the third long-term storage position B′ of FIG. 2B, the handle assembly may be pulled upwardly by the operator, preferably without actuation of the release apparatus 200. When the handle assembly 102 reaches the second storage position B, the locking portions 208 and 215 may engage the second recesses 126. The engagement of the locking portions 208 and 215 may provide a slight detent so that the operator knows the handle is in the second storage position B. The operator may leave the handle assembly 102 in the second storage position B, or continue to pull the handle until the locking portions 208 and 215 engage the first recesses 124 and lock the handle assembly in the first operating position A (see FIG. 2A).

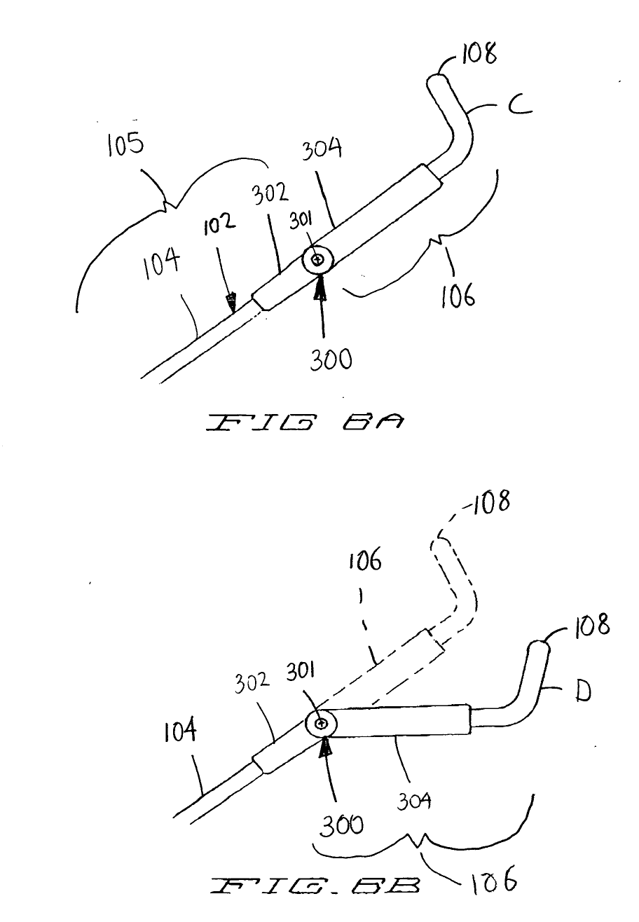

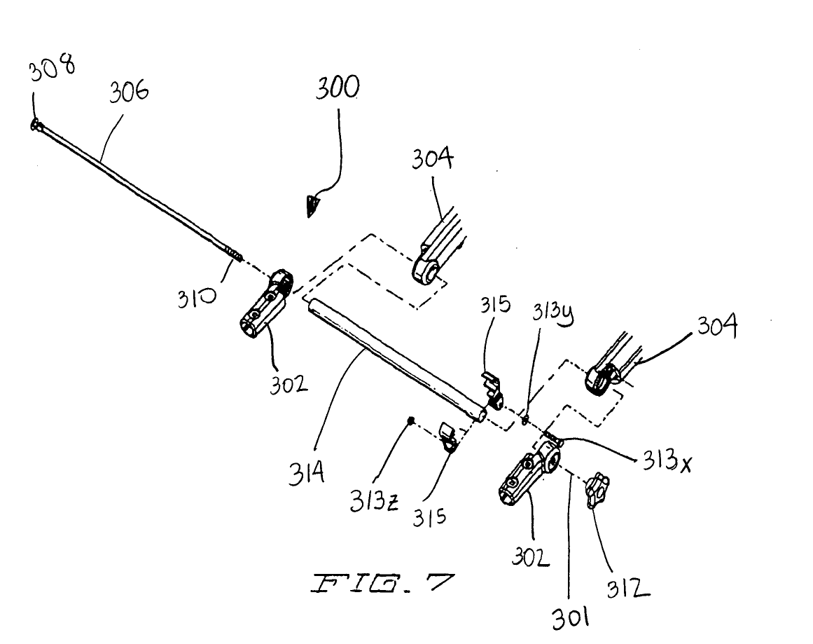

FIGS. 6A and 6B illustrate the upper section 106 of the handle assembly 102 in both a first, e.g., upper, use position C (FIG. 6A) and a second, e.g., lower, use position D (in solid lines in FIG. 6B). As described above, the gripping portion 108 of the upper section 106 may be moved between the first use position C and the second use position D to accommodate operators of varying heights. This motion may result from pivoting about the pivot assembly 300.

FIG. 7 illustrates an exploded view of the pivot assembly 300 in accordance with one embodiment of the invention. In this particular embodiment, a pair of first or lower caps 302 may attach, e.g., bolt or clamp, to upper ends of the handle attachment members 104, while a pair of second or upper caps 304 may attach to the lower ends of the upper section 106 of the handle assembly 102. The caps 302 and 304, as further described below, may engage one another in a manner that permits relative pivoting about the pivot axis 301. While described as separate cap members, other embodiments may modify the ends of the upper and lower handle sections such that separate caps are not required.

A tie rod 306 may extend through the caps 302 and 304. The tie rod 306 may have a head 308 at a first end and a threaded portion 310 at a second end. The threaded portion 310 may engage a fastener, e.g., a threaded knob 312, which may be loosened or tightened by the operator. A spacer, e.g., tube 314, may also be provided between the caps 304 to maintain the desired separation between the handle attachment members 104.

In the illustrated embodiment, the tube 314 may hold one or more brackets 315 operable to support a cable or the like. The bracket 315 may be formed in halves (as shown) that are secured to one another with fasteners, e.g., bolt 313x, washer 313y, and nut 313z.

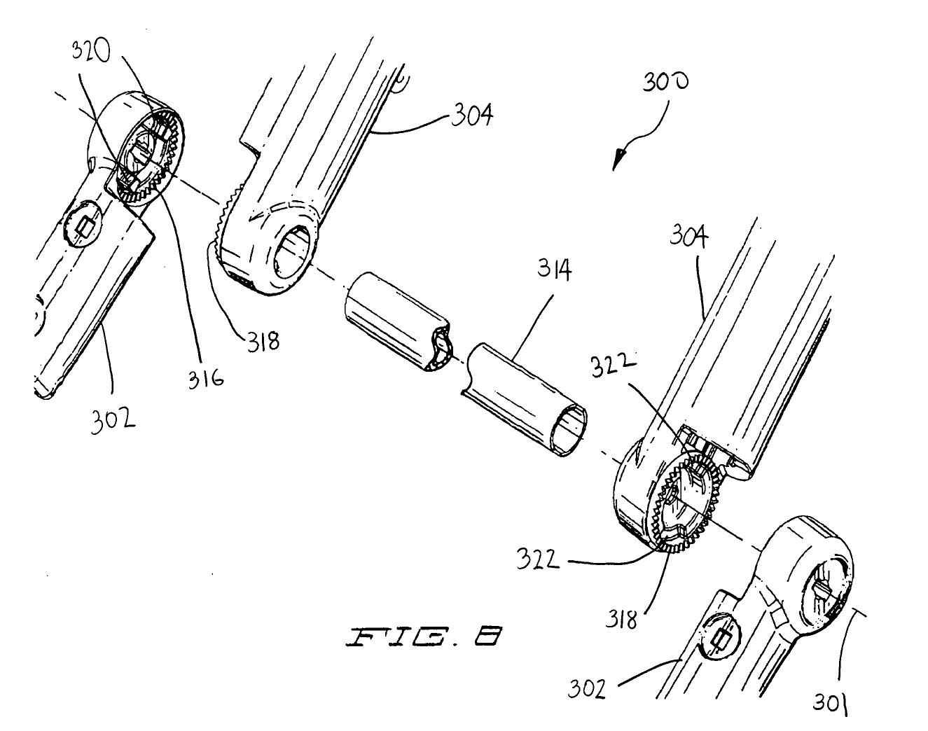

FIG. 8 is an enlarged partial view of the pivot assembly 300. As illustrated in this view, each cap 302 may include a series of second serrations 316 operable to engage corresponding and interlocking first serrations 318 in the opposing caps 304. The engagement of the serrations 316 and 318 permits interlocking of the upper section 106 with the lower section 105 of the handle assembly 102 in more than one relative position.

In some embodiments, the pivot assembly 300 may include optional stop members to limit the range of pivotal motion of the upper section 106 of the handle assembly 102. For example, the caps 302 may each include one or more tabs 320 that fit within arc-shaped slots 322 of the caps 304. The slots 322 are preferably sufficiently large to permit relative rotation of the cap members 304 relative to the cap members 302 over the desired range of motion.

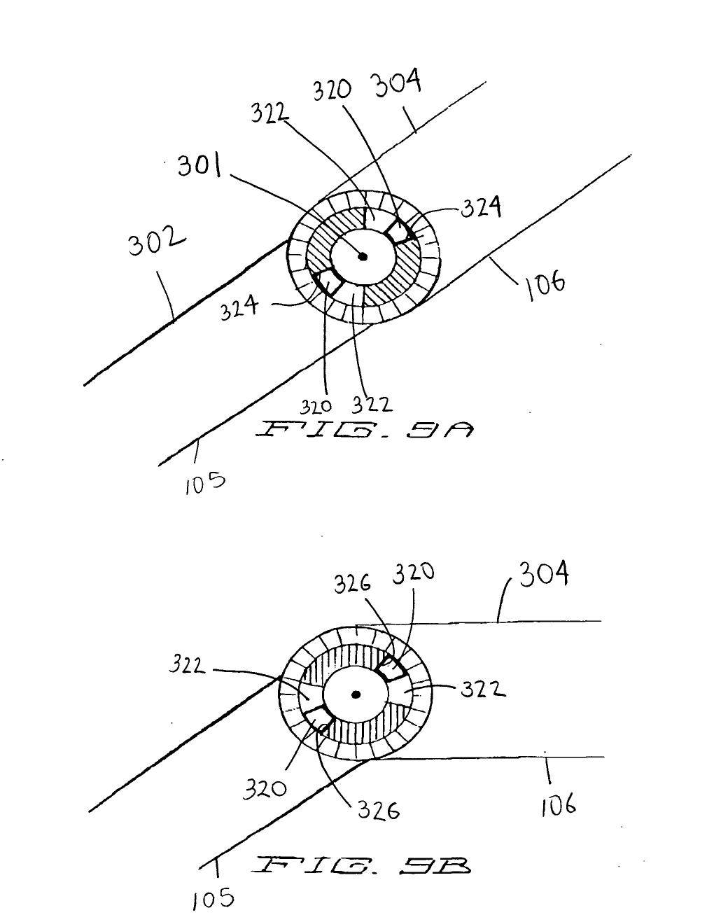

FIG. 9A illustrates a cutaway view of the pivot assembly 300 with the upper section 106 of the handle assembly 102 in the C position (see FIG. 6A). In this view, the tabs 320 are abutting a first side 324 of each slot 322. However, in the D position (see FIG. 6B), the upper section 106 has been rotated until the tabs 320 abut a second side 326 of each slot 322 as illustrated in FIG. 9B.

To move the upper section 106 of the handle assembly 102 between the first use position C and the second use position D, the operator may loosen the threaded knob 312 (FIG. 7) sufficiently to provide a gap between the respective caps 302 and 304. When sufficiently separated, the serrations 316 and 318 no longer interlock to hold the upper section 106 in place. As a result, the operator may pivot the upper section 106 over the range of motion permitted by the tabs 320 and slots 322. When the upper section 106 reaches the new position (position C, position D, or any position between that is accommodated by the serrations 316 and 318), the threaded knob 312 may be tightened on the tie rod 306 until the serrations are sufficiently engaged between each pair of caps 302 and 304. The tube 314 permits the tie rod 306 to tighten snugly without substantial deflection of the handle attachment members 104.

While embodiments that permit most any degree of rotation of the upper section are possible, the angle between position C (wherein the upper section 106 is generally contained within a plane of the lower section 105 as shown in FIG. 6A) and position D may be about 5 degrees or more, more preferably about 10 degrees or more, and most preferably about 30 degrees or more. For example, in the illustrated embodiment, the angular displacement is about 36 degrees. The serrations 316 and 318 may be sized to allow for about 5 discrete use positions of the upper section 106 over this 36 degree angular range.

Although illustrated herein as having the first use position C wherein the upper section 106 is generally within the plane defined by the lower section 105, this is not limiting. For example, the slots could be positioned to permit pivoting of the upper section 106 upwardly (counterclockwise in FIGS. 6A and 6B) so that the gripping portion 108 may be located for operation at an elevation higher than that shown in FIG. 6A.

As shown in FIG. 2B, the pivot assembly 300 may also permit repositioning of the upper section 106 for compact storage. For example, the pivot assembly 300, e.g., threaded knob 312, may be loosened to the point where the tabs 320 completely disengage from the slots 322. As a result, the upper section 106 may pivot beyond the range defined by the stops, e.g., to a position E as shown in FIG. 2B. When the upper section 106 is in the position E, it may form an angle of about, for example, 90 degrees (although most any angle is possible), with the plane of the lower section 105. To keep the upper section in the position E, the threaded knob 312 may be gently tightened.

Pivoting of the upper section 106 to the E position as illustrated in FIG. 2B may be beneficial for storage. For example, folding the upper section 106 of the handle assembly 102 to the position E may allow reduced overall handle height when the handle assembly is in the second storage position B. Moreover, placing the upper section of the handle assembly 102 in the E position may further reduce the storage volume of the mower 50 when the handle assembly 102 is in the third long term storage position B′ as shown.

Mowers and handle systems in accordance with embodiments of the present invention may thus provide various advantages. For instance, the handle assembly 102 of the present invention may be locked in the operating position with both handle members 104 being substantially restrained against relative rotation by the first recesses 124. However, the handle assembly 102 may be unlocked with a simple operator action (e.g., applying force to a single lever member) and pivoted to its storage position where it may be detented or held in place by the handle system. The handle assembly 102 may also be easily returned to the first operating position simply by pulling on the handle assembly without further interaction with the release apparatus. Moreover, other embodiments of the present invention may provide an upper section of the handle assembly that is movable between two or more use positions. As a result, operators of different heights may adjust the gripping portion of the upper section to satisfy their particular preference.

Illustrative embodiments of this invention are described and reference has been made to possible variations within the scope of this invention. These and other variations, modifications, and combinations of the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

What is claimed is:

1. A walk-behind power equipment unit comprising:
a housing operable for movement over a surface;
a handle assembly comprising a first and a second handle attachment member, wherein the first and second handle attachment members are pivotally coupled to the housing; and
a handle assembly release apparatus comprising interconnected and transversely offset first and second locking portions each pivotally coupled to the housing, wherein the first and second locking portions operatively engage the first and second handle attachment members, respectively, to lock the handle assembly in a first operating position.

2. The unit of claim 1, wherein the first and second locking portions may further operatively engage the first and second handle attachment members, respectively, to hold the handle assembly in a second storage position

3. The unit of claim 1, wherein the release apparatus further comprises a lever member operatively coupled to both the first and second locking portions, the lever member proximate a first side of the unit.

4. The unit of claim 1, further comprising a torsion spring to bias the first and second locking portions in a first direction.

5. The unit of claim 1, wherein the release apparatus further comprises a transverse crossbar connecting the first and second locking portions.

6. The unit of claim 1, wherein the first handle attachment member comprises a first hub and the second handle attachment member comprises a second hub, wherein each of the first and second hubs is pivotally coupled to the housing.

7. The unit of claim 6, wherein the first locking portion engages a first recess in the first hub when the handle assembly is in the first operating position, and engages a second recess in the first hub when the handle assembly is in a second storage position.

8. The unit of claim 6, wherein the first hub comprises one or more recesses operable to receive the first locking portion of the release apparatus, and the second hub comprises one or more recesses operable to receive the second locking portion.

9. A handle system for use with a walk-behind power equipment unit having a housing operable for movement over a surface, wherein the handle system comprises:
a handle assembly comprising a first and a second handle attachment member each pivotally coupled to the housing, wherein the handle assembly may pivot, relative to the housing, between a first operating position and a second storage position; and
a handle assembly release apparatus coupled to the housing, wherein the release apparatus comprises interconnected and transversely offset first and second locking portions for operatively engaging the first and second handle attachment members, respectively, to secure the handle assembly in the first operating position.

10. The system of claim 9, wherein the handle assembly further comprises a gripping portion pivotally coupled to the first and second handle attachment members, the gripping portion movable between at least two different use positions.

11. The system of claim 10, wherein the gripping portion is pivotable about a transverse horizontal axis.

12. The system of claim 9, wherein the first handle attachment member comprises a first hub and the second handle attachment member comprises a second hub, wherein each of the first and second hubs is pivotally coupled to the housing.

13. The system of claim 12, wherein the first locking portion engages a first recess in the first hub when the handle assembly is in the first operating position, and engages a second recess in the first hub when the handle assembly is in the second storage position.

14. A walk-behind lawn mower comprising:
a housing operable for movement over a ground surface;
a handle assembly comprising a first handle attachment member and a transversely offset second handle attachment member;
a first hub attached to a first end of the first handle attachment member and a second hub attached to a first end of the second handle attachment member, wherein the first and second hubs are each pivotally coupled to the housing; and
a handle assembly release apparatus coupled to the housing, the release apparatus comprising interconnected first and second locking portions operable to selectively engage the first and second hubs, respectively, to lock the handle assembly in a first operating position.

15. The mower of claim 14, wherein the first and second locking portions are further operable to selectively engage the first and second hubs, respectively, to hold the handle assembly in a second storage position.

16. The mower of claim 15, wherein the first locking portion engages a second recess of the first hub when the handle assembly is in the second storage position.

17. The mower of claim 14, wherein the first locking portion comprises a protrusion operable to engage a first recess of the first hub when the handle assembly is in the first operating position.

18. The mower of claim 14, wherein the first and second locking portions are pivotally coupled to the housing for pivoting about a transverse horizontal axis.

19. The mower of claim 14, further comprising a biasing member operable to bias the first locking portion towards the first hub.

20. The mower of claim 14, wherein the release apparatus further comprises a lever member operable to disengage the first and second locking portions from the first and second hubs.

21. The mower of claim 20, wherein the first locking portion comprises a protrusion formed on the lever member.

22. The mower of claim 14, wherein the release apparatus further comprises a transverse member connecting the first and second locking portions.

23. The mower of claim 22, wherein a portion of the transverse member forms the second locking portion.

24. The mower of claim 14, wherein the handle assembly further comprises: an upper section comprising a gripping portion; and a pivot assembly coupling the upper section to the first and second handle attachment members.

25. The mower of claim 24, wherein the upper section pivots, relative to the first and second handle attachment members, about a horizontal axis.

26. The mower of claim 24, wherein the upper section comprises first serrations operable to engage interlocking second serrations associated with the first and second handle attachment members.

27. The mower of claim 24, wherein the pivot assembly comprises stop members for limiting the pivotal movement of the upper section.

28. A walk-behind lawn mower comprising:
a housing operable for movement over a ground surface; and
a handle system attached to the housing, wherein the handle system comprises:
a lower section comprising first and a second handle attachment members each pivotally coupled to the housing, wherein the lower section may pivot between a first operating position and a second storage position;
an upper section comprising a gripping portion, the upper section coupled to the lower section, wherein the upper section selectively pivots, relative to the lower section, between two or more use positions; and
a handle assembly release apparatus coupled to the housing, wherein the release apparatus comprises interconnected and transversely offset first and second locking portions for operatively engaging the first and second handle attachment members, respectively.

29. The mower of claim 28, wherein the upper section of the handle assembly may be secured between a first use position, wherein the upper section is generally within a plane defined by the lower section, to a second use position, wherein the upper section forms an angle of about 5 degrees or more with the plane of the lower section.

30. The mower of claim 29, wherein the angle is about 10 degrees or more.

31. The mower of claim 30, wherein the angle is about 30 degrees or more.

32. A walk-behind lawn mower comprising:
a housing operable for movement over a ground surface; and
a handle system attached to the housing, wherein the handle system comprises:
a lower section comprising first and second handle attachment members each pivotally coupled to the housing, wherein the lower section may pivot between a first operating position and a second storage position; and
an upper section comprising a gripping portion, the upper section coupled to the lower section, wherein the upper section selectively pivots, relative to the lower section, between two or more use positions.

33. The mower of claim 32, wherein the upper section pivots, relative to the lower section, about a horizontal axis.

34. The mower of claim 32, wherein the upper section comprises first serrations operable to engage interlocking second serrations associated with the lower section.

35. The mower of claim 32, wherein the handle assembly further comprises a pivot assembly coupling the upper section to the lower section, wherein the pivot assembly comprises stop members for limiting the pivotal movement of the upper section.
